(19) United States
(12) Patent Application Publication
(10) Pub. No.: US 2008/0070621 A1
(43) Pub. Date: Mar. 20, 2008

(54) Digital cordless phone having remote control functionality

(75) Inventors: Kenneth Wisheng Ou Yang, Taipei City (TW); Yin-Kun Huang, Jhubei City (TW); Chih-Yuan Lee, Sanjhih Township (TW); Chih-Sheng Hsu, Daliao Township (TW)

Correspondence Address: BACON & THOMAS, PLLC, 625 SLATERS LANE, FOURTH FLOOR, ALEXANDRIA, VA, 22314, US

(73) Assignee: F3 Incorporation, Hsinchu (TW)

(21) Appl. No.: 11/649,905

(22) Filed: Jan. 5, 2007

(30) Foreign Application Priority Data
Aug. 10, 2006 (TW) 095129401

(51) Int. Cl. H04M 1/00

(52) U.S. Cl. 455/556.1; 340/825.72; 455/41.2; 340/825.22; 455/566

(57) ABSTRACT

The present invention is to provide a digital cordless phone having remote control functionality. When a telephone connection is established upon transmitting and receiving wireless telephony signals by a wireless transceiver module, an MCU receives control signals from a remote terminal via the telephone connection to control the remote control module, by which the wireless transmission module is initiated to send out the corresponding wireless control signals; when an internet connection is established upon transmitting and receiving wireless internet signals by the wireless transceiver module, the MCU can download a control code set for an electronic device from a website via the internet connection, and the control code set is stored in a memory.

### BACKGROUND OF THE INVENTION

1. Field of the Invention

The present invention relates to a digital cordless phone and, more particularly, to digital cordless phone having remote control functionality.

2. Description of Related Art

Due to the rapid development in electronics technology, many electronic products that are utilized in our everyday lives, such as television sets, DVD players, stereo systems and etc, have long evolved from solely manual operation to nowadays remote operation with the use of remote control units. However, since each electronic device comes with its own corresponding remote control unit, one could expect an excessive number of remote control units taken place in many households, which would result in confusion during operation and trouble in keeping those units organized. Furthermore, the remote control units in the art are only applicable within 10 to 20 meters from their respective devices. Bounded by regulations and limited frequency that can be utilized, remote controlling over a longer distance becomes unattainable.

Telephone, on the other hand, is one of the rapidest and most convenient communicating means. As wireless telecommunication technology thrives in recent years, telephone has been evolved towards being cordless and mobile, e.g. Digital Enhanced Cordless Telecommunications (DECT). Therefore, to mitigate and/or obviate the aforementioned problems, the present invention integrates the remote control unit with the digital cordless phone as to combine the remote control units for the all the electronic devices there are in a household.

### SUMMARY OF THE INVENTION

A digital cordless phone having remote control functionality comprises a wireless transceiver module for transmitting and receiving wireless telephony signals upon which a telephone connection is established or for transmitting and receiving wireless internet signals upon which an internet connection is established; a memory for providing storage of at least one control code set for an electronic device; a microcontroller unit (MCU) connected to the wireless transceiver module and the memory respectively; a remote control module connected to the MCU; and a wireless transmission module connected to the remote control module for transmitting wireless control signals based upon the control code set to operate at least one electronic device.

When the telephone connection is established upon transmitting and receiving wireless telephony signals by the wireless transceiver module, the MCU can receive control signals from the remote terminal via the telephone connection to control the remote control module, by which the wireless transmission module is initiated to send out the corresponding wireless control signals. When the internet connection is established upon transmitting and receiving wireless internet signals by the wireless transceiver module, the MCU can download a control code set of an electronic device from a website via the internet connection, and then control code set is then stored in the memory.

That is, the digital cordless phone having remote control functionality of the present invention integrates the digital wireless phone with the remote control unit as to prevent users from confusing with one remote control unit to another during operation and to avoid inconvenience of keeping numbers of units in order.

The digital cordless phone having remote control functionality of the present invention further comprises a keypad module configured to provide inputs of commands on the digital cordless phone; and a switch button configured to provide switching to the original functions of the digital cordless phone or to provide the on/off switch for the remote control module for operating at least one electronic device when the switch button is pressed.

The digital cordless phone having remote control functionality can be further applied to a folding digital wireless phone, such that when phone is unfolded, the original functions of said digital wireless phone are provided; whereas the remote control module is initiated when the phone is folded.

The telephone connection as mentioned above can be established through public switch telephone network (PSTN) or be established upon Voice over Internet Protocol (VoIP).

Other objects, advantages, and novel features of the invention will become more apparent from the following detailed description when taken in conjunction with the accompanying drawings.

### BRIEF DESCRIPTION OF THE DRAWINGS

FIG. 1 is a block diagram illustrating the system components of the present invention.

FIG. 2 is a schematic diagram according to a preferred embodiment of the present invention.

FIG. 3 is a schematic diagram according to another preferred embodiment of the present invention.

### DETAILED DESCRIPTION OF THE PREFERRED EMBODIMENT

Reference will now be made in detail to the preferred embodiments of the present invention, and the examples of which are illustrated in the accompanying drawings.

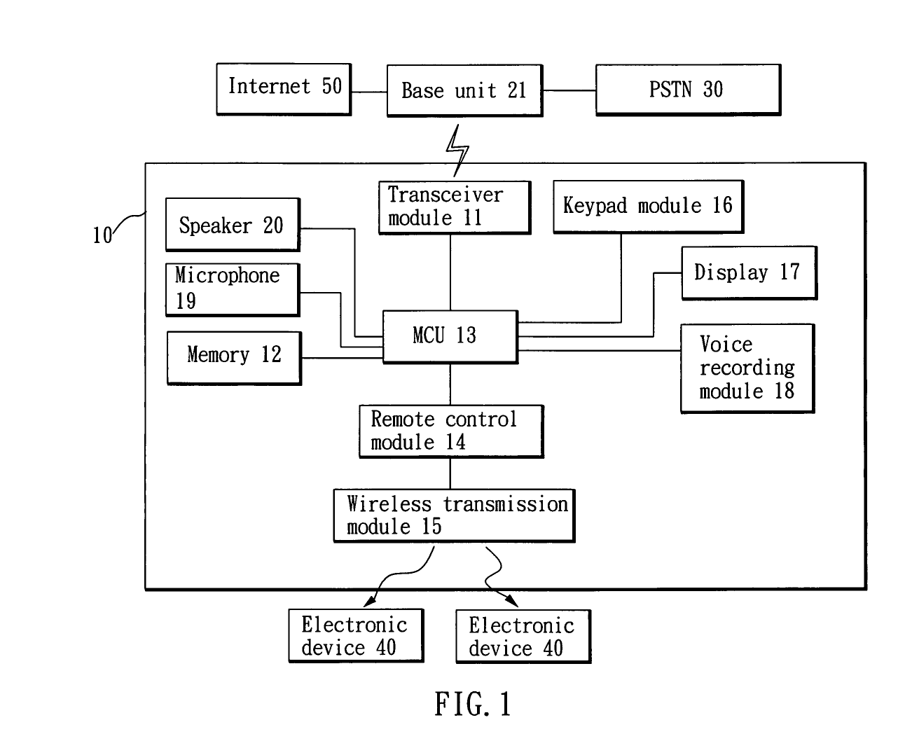

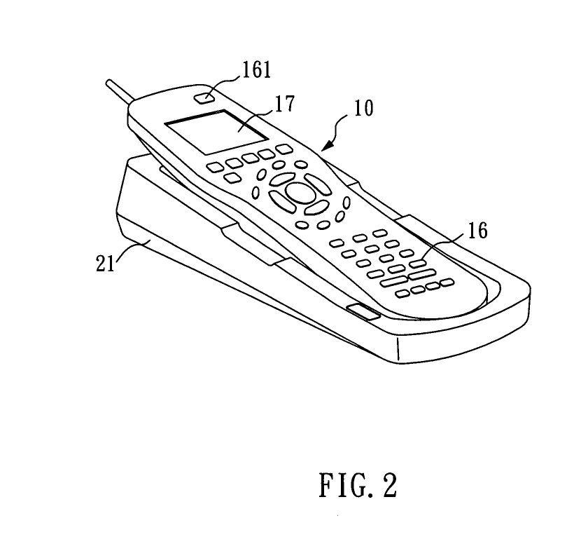

FIG. 1 is a block diagram illustrating the system components of the present invention. FIG. 2 is a schematic diagram according to a preferred embodiment of the present invention.

With reference to both FIG. 1 and FIG. 2, the present invention comprises a wireless transceiver module 11, a memory 12, an MCU 13, a remote control module 14, a wireless transmission module 15, a keypad module 16, a display 17, a voice recording module 18, a microphone 19 and a speaker 20. The digital cordless phone having remote control functionality 10 can be wirelessly coupled to a base unit 21, through which it is connected to the public switch telephone network 30 or to the internet 50.

The wireless transceiver module 11 is configured to transmit and receive wireless telephony signals for establishing a telephone connection or to transmit and receive wireless internet signals for establishing an internet connection. The memory 12 is to provide storage of control code sets for at least one electronic device 40, which can be a television set, a DVD player/recorder, a stereo system and an air conditioner. The MCU 13 is connected to the wireless transceiver module 11 and the memory 12 respectively. The remote control module 14 is connected to the MCU13. The wireless transmission module 15 is connected to the remote control module 14 and transmits wireless control signals according to the control code set for operating at least one electronic device 40. The display 17 is coupled to the MCU 13 to provide caller ID or to show the phone number being dialed. The voice recording module 18 is coupled to the MCU 13 to provide storage of voice messages of any unanswered call. The microphone 19 and the speaker 20 are both coupled to the MCU 13 to provide the input and the output of voice.

As shown in FIG. 1, when the present invention is used as a regular cordless phone, the wireless transceiver module 11 transmits/receives wireless telephony signals through the base unit 21 in order to establish a regular telephone connection with a regular phone user at a terminal of the public switch telephone network 30 or to establish a voice over internet protocol connection with an internet phone user at a terminal of the internet 50. Also the user is able to remotely control the electronic device 40 via a connection, that is, the MCU 13 can receive control signals, which are sent from a remote terminal of either the regular telephone connection or the internet connection, so as to control the remote control module 14 to initiate the wireless transmission module 15 for sending out the corresponding wireless control signals and remotely operating the corresponding electronic device 40.

On the other hand, when the present invention is utilized as a regular remote control, the MCU 13 receives control signals inputted by the operator as to control the remote control module 14 to initiate the wireless transmission module 15 for sending out the corresponding wireless control signals and remotely operating the corresponding electronic device 40. However, since new electronic devices are introduced at a persistent pace, the control code sets thereof must be updated accordingly. The digital cordless phone having remote control functionality 10 of the present invention utilizes wireless transceiver module 11 to transmit/receive wireless internet signals to establish an internet connection, with which the MCU 13 can download any control code set for any electronic device from a website. Any downloaded control code set will then stored in the memory 12 so as to update the remote control.

As shown in FIG. 2, the present invention further includes a keypad module 16 for inputting commands on the digital cordless phone 10. The keypad module 16 includes a trigger button 161. When the trigger button 161 is pressed, it allows the user to switch between original functionality of the digital cordless phone or to power on/off the remote control module 14 for operating electronic devices.

Integrating the remote control functionality with a cordless telephone, the present invention not only prevents users from confusing with one remote unit to another during operation, also the possibility of loss of remote units decreases, making one's living room tidier and more organized. The present invention also adds more value to the digital cordless phone by combining remote control functionality therewith.

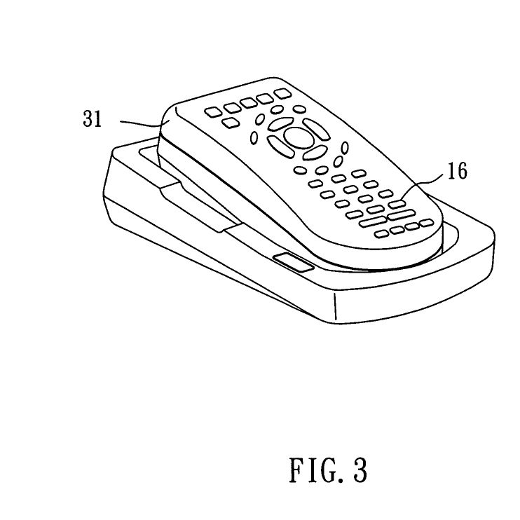

FIG. 3 is a schematic diagram according to another preferred embodiment of the present invention. The principle behind this preferred embodiment is mostly identical to the previous one, except that in this preferred embodiment, the digital cordless phone 10 can be applied to a folding digital cordless phone. As shown in FIG. 3, the keypad module 16 for the purpose of remote controlling is mounted on the upper casing 31. When the phone is unfolded, the original functions of the digital cordless phone 10 are provided; when the phone is folded, the remote control module 14 is then initiated, allowing users to operate the electronic device 40 by manipulating the buttons thereof.

Although the present invention has been explained in relation to its preferred embodiment, it is to be understood that many other possible modifications and variations can be made without departing from the scope of the invention as hereinafter claimed.

What is claimed is:

1. A digital cordless phone having remote control functionality comprising:
a wireless transceiver module for transmitting and receiving wireless telephony signals upon which a telephone connection is established, or for transmitting and receiving wireless internet signals upon which an internet connection is established;
a memory for providing storage of at least one control code set for an electronic device;
an MCU connected to said wireless transceiver module and said memory respectively;
a remote control module connected to said MCU; and
a wireless transmission module connected to said remote control module for transmitting wireless control signals based upon said control code set to operate said at least one electronic device;
when the telephone connection is established upon transmitting and receiving wireless telephony signals by said wireless transceiver module, said MCU receives control signals from the remote terminal via said telephone connection to control said remote control module, by which said wireless transmission module is initiated to send out the corresponding wireless control signals; when the internet connection is established upon transmitting and receiving wireless internet signals by said wireless transceiver module, said MCU can download a control code set of an electronic device from a website via said internet connection, and said control code set is stored in said memory.

2. The digital cordless phone having remote control functionality as claimed in claim 1 further comprises a keypad module configured to provide inputs of commands on said digital cordless phone; and a switch button configured to provide switching to the original functions of said digital cordless phone or to power on/off said remote control module for operating at least one electronic device when said switch button is pressed.

3. The digital cordless phone having remote control functionality as claimed in claim 1, wherein said digital cordless phone is applied to a folding digital cordless phone; when unfolded, the original functions of said digital cordless phone are provided; when folded, the remote control module is initiated.

4. The digital cordless phone having remote control functionality as claimed in claim 1 further comprises a display coupled to said MCU to provide caller IDs or to show the phone number being dialed.

5. The digital cordless phone having remote control functionality as claimed in claim 1 further comprises a voice recording module coupled to said MCU to provide storage of voice messages of any unanswered call.

6. The digital cordless phone having remote control functionality as claimed in claim 1 further comprises a microphone and a speaker, both coupled to said MCU, to provide the input and the output of voice.

7. The digital cordless phone having remote control functionality as claimed in claim 1, wherein said telephone connection is established through Public Switch Telephone Network (PSTN).

8. The digital cordless phone having remote control functionality as claimed in claim 1, wherein said telephone connection is established upon Voice over Internet Protocol (VoIP).
